(19) United States
(12) Patent Application Publication
(10) Pub. No.: US 2013/0021126 A1
(43) Pub. Date: Jan. 24, 2013

(54) TRANSFORMER

(71) Applicants: Michal Norbert GAJEWSKI, Warsaw (PL); Jan Erik KNUTSEN, Oslo (NO)

(72) Inventors: Michal Norbert GAJEWSKI, Warsaw (PL); Jan Erik KNUTSEN, Oslo (NO)

(21) Appl. No.: 13/495,834

(22) Filed: Jun. 13, 2012

(30) Foreign Application Priority Data
Jun. 16, 2011 (NO) 20110868

(51) Int. Cl. H01F 30/12; H01F 27/28

(52) U.S. Cl. 336/5; 336/220

(57) ABSTRACT

A transformer comprising columns, wherein each of the columns comprises a magnetic material, a length axis, an upper end, and a lower end, an upper yoke in contact with the upper end and a lower yoke in contact with the lower end, wherein at least yokes comprises two parallel sub-yokes and a yoke connector connecting the two parallel sub-yokes, at least one primary winding on at least one of the columns configured to produce alternating magnetic flux in a closed magnetic circuit defined by the columns and the yokes, at least one secondary winding on at least one of the columns, and at least one control winding on the yoke connector, wherein the at least one control winding is configured to produce direct magnetic flux in a closed magnetic circuit defined by the yokes and the respective yoke connector, wherein the respective yoke connector is in a magnetically symmetrical position.

### BACKGROUND OF THE INVENTION

1. Field of the Invention

The field of the present invention relates to a transformer for an electric power distribution system and, more specifically, to a high voltage transformer for an electric power distribution system in the form of an offshore system for electric power transmission from a power supply to a consumer means over a power transmission line comprising an offshore cable section.

2. Description of the Prior Art

Offshore systems may be used to pump oil and/or gas from wells below the sea floor. Such systems may include pumps driven by electric motors for the pumping of the oil and/or gas. Such pumps may be situated hundreds of kilometres from the shoreline and may be supplied with electric power from a power supply system arranged onshore. When power is supplied over cables of such length different problems may arise such as, for example, electrostatic charging of the cable feeding electricity to the pump. The electrostatic charging of the cable may give rise to an over-voltage at the pump motor, which ultimately may damage the electric insulation system of the pump motor, connection system, cable and/or topside electrical equipment. Furthermore, during operation of a pump connected to the power supply system, the load on the electric motor driving the pump may vary over time. Reduction of the load further enhances the problem with electrostatic charging of the cable feeding electricity to the pump. On the other hand, voltage drop in the cable under load may result in the electric motor being supplied with a voltage below nominal. This is very inconvenient and may lead to premature aging and, finally, to the thermal damage of the insulation of the windings of the electric motor.

In order to resolve these problems it is desirable to provide a control means for control of the voltage to the pump motor. The control means may be in the form of a transformer with a controllable voltage output. Traditionally a controllable voltage output from a transformer has been provided by arranging tappings on the windings, which tappings are brought out to terminals so that the number of turns on one winding can be changed. The voltage between each tapping is dependent on the number of turns between each tap. The taps are connected to a type of power switch called a tap changer. Tap changers are, however, mechanically complicated and require frequent maintenance, making them unsuitable for placement on the sea floor.

A magnetically influenced current or voltage regulator and a magnetically influenced transformer may only have a one-phase transformer design. For many reasons it is desirable to use three-phase voltage to drive high power applications such as pump motors for pumping oil from the sea floor. Three identical, independent converters for providing a three-phase output may be used.

A three phase flux-controlled type variable transformer may comprise a first and a second magnetic circuit and two separate magnetic cores. A control winding is arranged to induce a magnetic flux. The voltage from a secondary winding may be continuously changed by adjusting the exciting current flowing in the control winding. This type of transformer is, however, too complicated to make it suitable for placement on the sea floor.

A type of regulating power transformer with magnetic shunt may consist of a primary winding and a secondary winding positioned coaxial on the center column of an E-type stack of magnetic lamination pack, which is separated by a layer of I-type laminations having two coils wound thereon. The I-type laminations provide the function of the magnetic shunt for the flux generated by the primary coil and serve as the magnetic coupling between the E-type laminations on the primary side and the secondary side of the transformer.

### BRIEF SUMMARY OF THE INVENTION

According to an embodiment of the present invention, there is provided a transformer. The transformer comprises at least two columns, wherein each of the at least two columns comprises a magnetic material, a length axis, an upper end, and a lower end, an upper yoke in contact with the upper end of each of the at least two columns and a lower yoke in contact with the lower end of each of the at least two columns, wherein at least one of the upper yoke and the lower yoke comprises two parallel sub-yokes and a yoke connector connecting the two parallel sub-yokes, at least one primary winding on at least one of the at least two columns configured to produce alternating magnetic flux in a closed magnetic circuit defined by the at least two columns, the upper yoke, and the lower yoke, at least one secondary winding on at least one of the at least two columns; and at least one control winding on the yoke connector, wherein the at least one control winding is configured to produce direct magnetic flux in a closed magnetic circuit defined by the upper yoke or the lower yoke and the respective yoke connector, wherein the respective yoke connector is in a magnetically symmetrical position.

### BRIEF DESCRIPTION OF THE DRAWINGS

In the following detailed description of the present invention similar features in different figures will be denoted with the same reference numeral. It is to be noted that the drawings are not drawn to scale. In the drawings:

FIG. 1 shows a single phase transformer according to an embodiment of the present invention, comprising two columns and two yoke connectors;

FIG. 2 shows a three phase transformer according to an embodiment of the present invention, comprising a single yoke connector;

FIG. 3 shows a three phase transformer according to an embodiment of the present invention, comprising a two yoke connector;

FIG. 4 shows a connection of control windings in a transformer according to an embodiment of the present invention; and

FIG. 5 shows a transformer according to an embodiment of the present invention, connected to a motor on the sea floor.

### DETAILED DESCRIPTION OF THE INVENTION

An embodiment of the present invention provides a transformer for controlling the voltage to one or more power consumers, such as equipment placed on the sea floor, which transformer solves the problems in the prior art.

An embodiment of the present invention provides a transformer which is suitable for placement on the sea floor and from which it is possible to control the output voltage.

An embodiment of the present invention provides a transformer which is robust and uncomplicated while still providing the possibility of controlling the voltage output from the transformer.

An embodiment of the present invention provides a polyphase transformer comprising at least three primary windings, three secondary windings and at least one control winding with which it is possible to control the voltage output on the secondary windings, wherein the transformer is robust, compact and suitable for placement on the sea floor.

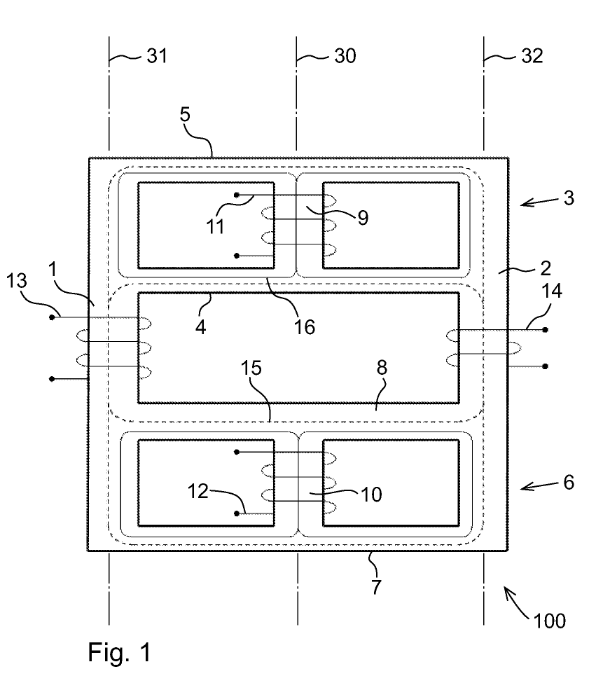

FIG. 1 shows a single phase transformer 100 according to an embodiment of the present invention comprising a core of magnetic material. The core comprises a first column 1 with a length axis 31, and a second column 2 with a length axis 32, an upper yoke 3 being in contact with the upper end of each column 1, 2, comprising a first sub-yoke 4 and a second sub-yoke 5, and a lower yoke 6 comprising a first sub-yoke 7 and a second sub-yoke 8. The transformer 100 also comprises an upper yoke connector 9 connecting the upper sub-yokes 4, 5, and a lower yoke connector 10 connecting the lower sub-yokes 7, 8. The yoke connectors 9, 10, have a common length axis 30, which also is the symmetry axis for the transformer 100. The transformer 100 further comprises an upper control winding 11 arranged on the upper yoke connector 9 and a lower control winding 12 arranged on the lower yoke connector 10. The control windings 11, 12 are arranged to produce a magnetic flux in the yokes 3, 6. A primary winding 13 is arranged on the first column 1 and a secondary winding 14 is arranged on the second column 2.

During operation of the transformer 100, a primary alternating voltage is applied to the primary. winding 13. The primary winding 13 is thus arranged to produce an alternating magnetic flux in a closed magnetic circuit represented by the columns 1, 2 and the yokes 3, 6. When no voltage is applied to the control windings 11, 12 the primary voltage produces a magnetic flux depicted by the dotted line 15. The alternating magnetic flux induces a secondary voltage over the secondary winding 14. When a static control voltage is applied on the upper control winding 11, a direct (constant) magnetic flux, depicted by the solid line 16, is produced in the yoke connector 9 and the sub-yokes 4, 5, of the upper yoke 3. In the corresponding way a static control voltage on the lower control winding 12 produces a constant magnetic flux in the yoke connector 10 and the sub-yokes 7, 8, of the lower yoke 6. The control windings 11, 12 are thus arranged to produce a direct magnetic flux in a closed magnetic circuit represented by the yokes 3, 6 and the yoke connectors 9, 10. In one embodiment, a current source is used to supply the control windings 11, 12. If the control voltage(s) is(are) sufficiently high the magnetic material in the yoke connector(s) 9, 10 and the sub-yokes 4, 5, 7, 8, will be saturated and the reluctance of these parts will increase, which prevents the magnetic flux produced by the primary voltage to reach the secondary winding 14. On the other hand leakage flux from the primary winding 13 will increase. This will finally lead to substantially zero voltage over the secondary winding 14. By controlling the voltage over the control windings 11, 12, the voltage over the secondary winding 14 may be controlled in a designed range.

In one embodiment, the winding axis of the primary winding 13 and the winding axis of the secondary winding 14 are essentially coaxial to the length axis 31, 32 of their respective columns 1, 2. In this embodiment, the efficiency of the conversion of the electrical energy in the primary winding 13 to the electrical energy in the secondary winding 14 through the magnetic flux in the columns 1, 2 is improved.

In one embodiment, both the upper yoke and the lower yoke comprise two parallel sub-yokes 4, 5, 7, 8 and a yoke connection 9, 10 connecting the two sub-yokes with a length axis for each yoke connector 9, 10. In one embodiment, the transformer 100 also comprises a control winding arranged 11, 12 on each of the yoke connectors 9, 10. By having two yoke connectors 9, 10 and two control windings 11, 12, the voltage over the secondary windings 14 may be controlled more accurately.

In one embodiment, the control windings 11, 12 may be connected in series, wherein only one control circuit is required to control such serially connected control windings 11, 12.

In one embodiment, the length axes of the yoke connectors 9, 10 may be essentially parallel to each other and, in one embodiment, are coaxial. A symmetric transformer is more easily provided in that way.

In one embodiment, the length axes of the yoke connectors 9, 10 may constitute a common symmetry axis. Thus, in case the transformer 100 has two yoke connectors 9, 10, their length axes coincide. In one embodiment, the columns 1, 2 are arranged symmetrically around the symmetry axis.

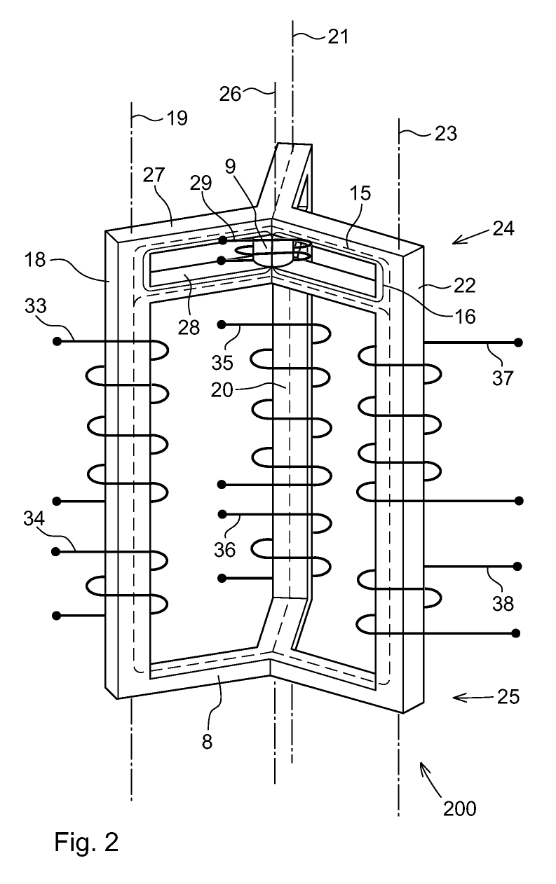

FIG. 2 shows a three phase transformer 200 according to an embodiment of the present invention comprising a single yoke connector 9, The transformer 200 comprises a first column 18 with a length axis 19, a second column 20 with a length axis 21 and a third column 22 with a length axis 23. The columns 18, 20, 22 are connected with an upper yoke 24 and a lower yoke 25. The transformer 200 also comprises a symmetry axis 26 around which the columns 18, 20, 22 are arranged symmetrically. The upper yoke 24 comprises a first sub-yoke 27 and a second sub-yoke 28, which sub-yokes 27, 28, are connected by said yoke connector 9 in a magnetically symmetrical position. A control winding 29 is arranged on the yoke connector 9. A first primary winding 33 and a first secondary winding 34 are arranged on the first column 18. A second primary winding 35 and a second secondary winding 36 are arranged on the second column 20. A third primary winding 37 and a third secondary winding 38 are arranged on the third column 22.

The operation of the three phase transformer 200 is equivalent to the operation of the one phase transformer 100 described above. Thus, when a control winding 29 is supplied with sufficient current the magnetic material in the upper yoke 24 will be saturated. The magnetic flux produced by the primary windings 33, 35, 37 is then prevented from passing the upper yoke 24 which will lead to a considerably lower output voltage on the secondary windings 34, 36, 38. By controlling the current of the control winding 29 the voltage on the secondary windings 34, 36, 38 may be controlled.

In one embodiment, a transformer comprises a column for each phase. In one embodiment where the transformer 200 is a polyphase transformer, it may comprise a primary winding 33, 35, 37 and a secondary winding 34, 36, 38 on each one of the columns 18, 20, 22. By having the primary winding 33, 35, 37 and the secondary winding 34, 36, 38 on the same column 18, 20, 22 the magnetic coupling may be optimized.

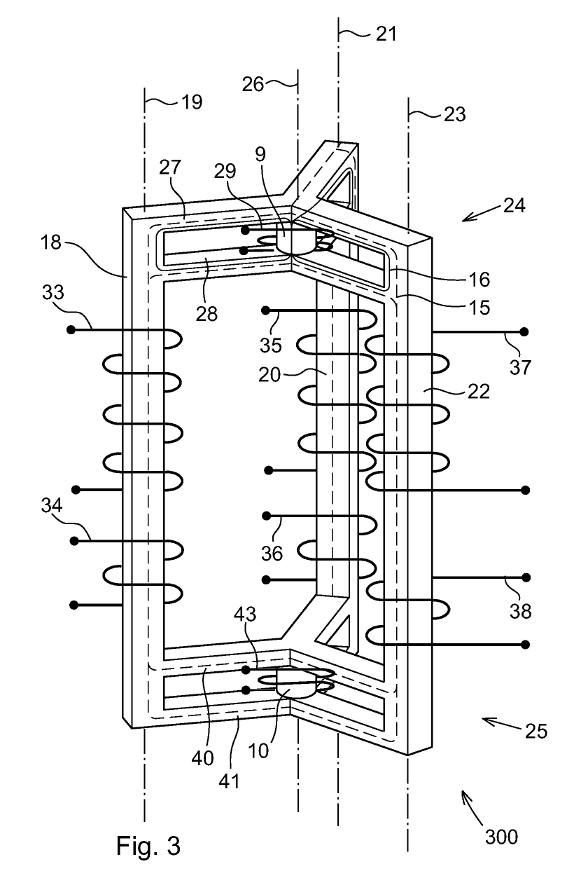

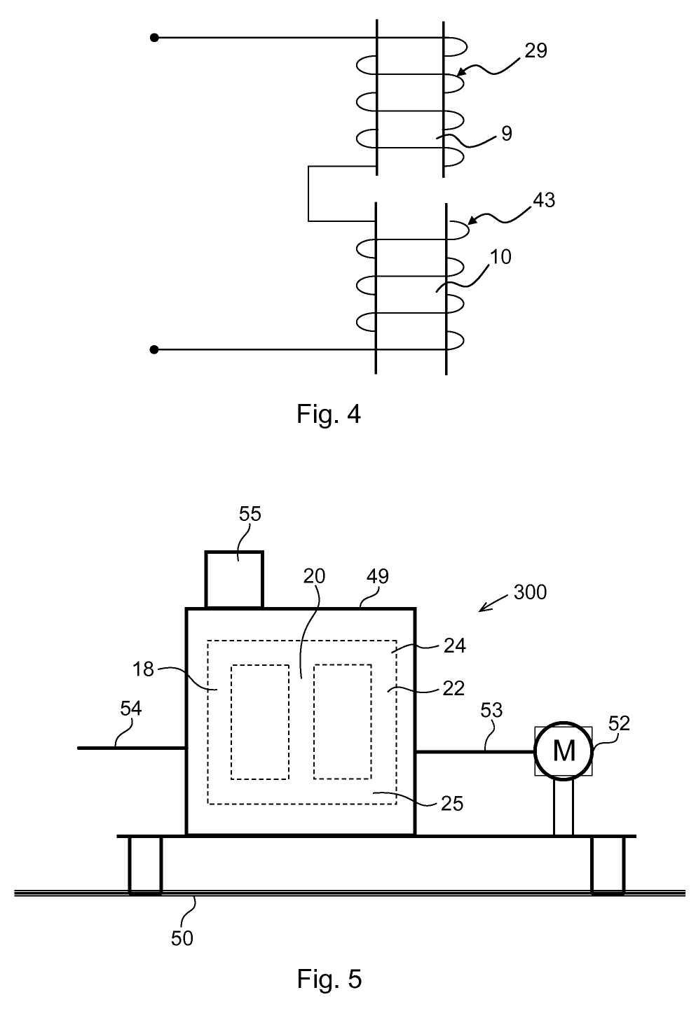

FIG. 3 shows a three phase transformer 300 according to an embodiment of the present invention comprising two yoke connectors 9, 10. The only difference between this transformer 300 and the transformer 200 in FIG. 2 is that also the lower yoke 25 comprises a first sub-yoke 40 and a second sub-yoke 41, which are connected by a lower yoke-connector 10 on which a second control winding 43 is arranged. By having two yoke connectors 9, 10 and two control windings 29, 43, the secondary voltage may be controlled more precisely. Furthermore, when alternating voltages are applied on the primary windings 33, 35, 37 some of the magnetic flux produced may be coupled into the yoke connectors 9, 10, despite them being arranged in a magnetically symmetrical position. The magnetic flux that is coupled into the yoke connectors 9, 10 in this way produces a voltage in the control windings 29, 43 which may damage the electronics connected to the control windings 29, 43. By having the control windings 29, 43, arranged as shown in FIG. 4 with their winding directions opposite to each other, the voltage over the control windings 29, 43, which stems from magnetic fluxes induced by the voltages applied on the primary windings 33, 35, 37 may be lowered considerably.

FIG. 5 shows a transformer 300 connected to a motor 52, which both are arranged on the sea floor 50. The transformer 300 comprises a cover 49 which encloses the columns 18, 20, 22, the yokes 24, 25, and the windings 33, 34, 35, 36, 37, 38. The cover 49 is filled with oil. In one embodiment, the oil insulates the windings 33, 34, 35, 36, 37, 38 and provides cooling for the core and the windings 33-38. The transformer 300 is arranged on the sea floor 50. The secondary windings 34, 36, 38 of the transformer 300 are connected to equipment in the form of a motor 52 by means of a cable 53. The primary windings 33, 35, 37 of the transformer 300 are connected to a supply cable 54 which supplies electrical energy from a power plant on-shore. A control device 55 is connected to the transformer 300 and is arranged to control the current on the control windings 29, 43. The control device 55 may be arranged to apply a small portion of the power supplied with the supply cable 54.

Embodiments of the present invention are particularly suited for use with high voltage applications. In one embodiment, the primary windings 33, 35, 37 may be arranged for a voltage of at least 400 V or, in another embodiment, for a voltage of at least 1000 V.

In one embodiment, the yokes 24, 25 and the columns 18, 20, 22 together form a single core. Thus, the transformer 200 is a single core transformer. There is one common magnetic circuit for all phases. It provides larger power density of the converter.

The described embodiments may be amended in many ways without departing from the spirit and scope of the present invention which is limited only by the appended claims.

In the described embodiments the windings are shown as being separated along the columns. It is however possible to have the windings arranged integrated with each other.

Even though polyphase transformers almost exclusively are arranged with three phases, it is possible within the scope of the present invention to arrange the transformer with any number of phases, for example, with more than three phases and columns or with only one phase and two columns.

The windings of the transformer can be connected together in suitable group(s) of connection.

A transformer according to an embodiment of the present invention can work as controllable reactive power compensator and voltage regulator for long cable lines, where reactive power compensation and voltage regulation are required. It can also work as a voltage regulator for long overhead lines.

A transformer according to an embodiment of the present invention may operate as step up or step down transformer.

A transformer according to an embodiment of the present invention can be placed on the sea floor connected to one or more power consumers, such as power equipment on the sea floor.

What is claimed is:

1. A transformer, comprising:
at least two columns, wherein each of the at least two columns comprises:
a magnetic material;
a length axis;
an upper end; and
a lower end;
an upper yoke in contact with the upper end of each of the at least two columns and a lower yoke in contact with the lower end of each of the at least two columns, wherein at least one of the upper yoke and the lower yoke comprises two parallel sub-yokes and a yoke connector connecting the two parallel sub-yokes;
at least one primary winding on at least one of the at least two columns configured to produce alternating magnetic flux in a closed magnetic circuit defined by the at least two columns, the upper yoke, and the lower yoke;
at least one secondary winding on at least one of the at least two columns; and
at least one control winding on the yoke connector, wherein the at least one control winding is configured to produce direct magnetic flux in a closed magnetic circuit defined by the upper yoke or the lower yoke and the respective yoke connector, wherein the respective yoke connector is in a magnetically symmetrical position.

2. The transformer according to claim 1, wherein the winding axis of the at least one primary winding and the winding axis of the respective at least one secondary winding are essentially coaxial with the length axis of the respective column.

3. The transformer according to claim 1, wherein each of the upper yoke and the lower yoke comprises two parallel sub-yokes and a yoke connector connecting the two parallel sub-yokes, wherein each yoke connector comprises a length axis.

4. The transformer according to claim 3, wherein the transformer comprises a control winding on each yoke connector.

5. The transformer according to claim 4, wherein the control windings are connected in series.

6. The transformer according to claim 4, wherein the length axes of the yoke connectors are essentially coaxial to each other.

7. The transformer according to claim 6, wherein the control windings are connected to induce magnetic flux in opposite directions.

8. The transformer according to claim 1, wherein the transformer is a polyphase transformer.

9. The transformer according to claim 8, wherein the at least two columns comprise a column for each phase.

10. The transformer according to claim 9, comprising a primary winding and a secondary winding on each of the at least two columns.

11. The transformer according to claim 3, wherein the length axis of each yoke connector constitutes a common symmetry axis, and wherein the at least two columns are arranged symmetrically around the length axis of each yoke connectors.

12. The transformer according to claim 8, comprising three columns.

13. The transformer according to claim 1, further comprising a cover configured to enclose the at least two columns, the upper yoke, the lower yoke, the at least one primary winding, the at least one secondary winding, and the at least one control winding, wherein the cover is filled with oil.

14. The transformer according to claim 1, wherein the at least one primary winding is arranged for a voltage of at least about 400 V.

15. The transformer according to claim 1, wherein the transformer is placed on a sea floor and is connected to equipment on the sea floor.
